(19) United States
(12) Patent Application Publication
(10) Pub. No.: US 2018/0327563 A1
(43) Pub. Date: Nov. 15, 2018

(54) Production Of Fine Cell Foams Using A Cell Aging Inhibitor

(71) Applicant: Evonik Degussa GmbH, Essen (DE)

(72) Inventors: Michael Klostermann, Essen (DE); Carsten Schiller, Ratingen (DE); Joachim Venzmer, Essen (DE); Christian Eilbracht, Herne (DE)

(73) Assignee: Evonik Degussa GmbH, Essen (DE)

(21) Appl. No.: 15/774,150

(22) PCT Filed: Nov. 21, 2016
(86) PCT No.: PCT/EP2016/078239

§ 371 Date: May 7, 2018

(30) Foreign Application Priority Data
Dec. 1, 2015 (EP) 15197177.7

(51) Int. Cl. C08J 9/00; C08J 9/12

(52) U.S. Cl. CPC C08J 9/0019; C08J 9/0042; C08J 9/12; C08J 2203/144; C08J 2203/146; C08J 2375/04; C08J 2203/166; C08J 2203/182; C08J 2205/044; C08J 2205/10; C08J 2203/164

(57) ABSTRACT

The use of an Ostwald hydrophobe in the production of polymer foams, preferably polyurethane foam, in particular rigid polyurethane foam, from liquid reaction mixtures, to retard cell ageing, in particular to retard cell ageing caused by Ostwald ripening, is described.

The field of the present invention is foams, preferably polyurethane foams.

Foams, in particular polymer foams, are a class of materials that is used widely and in many different applications. Morphology (“cell structure”) is mostly a decisive factor determining usage properties here. By exerting influence on the cell structure in a controlled manner during the production of the foams it is possible to adjust the properties to be appropriate to particular requirements.

Development of a foam structure is achieved through formation of a gas (e.g. via evaporation of a blowing agent) in the matrix while this is still liquid—in the case of polymer foams this being mostly a melt of a thermoplastic polymer or a reaction mixture which is made of monomeric or oligomeric raw materials and which hardens with crosslinking—and migration of the gas out of the liquid phase with development of foam bubbles (“cells”). This foaming process can be broadly divided into three steps comprising the nucleation of the blowing agent to give cell nuclei, the growth of the cell nuclei to give actual foam cells and the ageing of the foam cells. The term nucleation generally means the release of very small, very finely dispersed gas bubbles into the liquid matrix. In contrast to this, the term cell growth means the increase in size of existing foam cells caused by inwards diffusion of blowing agent dissolved in the foam matrix. The term cell ageing in turn describes a change of cell size and/or cell number caused by interaction between two or more cells. This cell ageing can firstly result from direct fusion of two or more cells. This phenomenon is also called coalescence. Cell ageing can secondly result from what is known as Ostwald ripening. This is not caused by direct fusion of two or more cells, but instead is associated with cell gas diffusion from small bubbles towards larger bubbles, causing slow shrinkage of smaller gas bubbles while the size of larger gas bubbles increases. This process usually continues until the final disappearance of the smaller gas bubbles. However, cell ageing during the production of foams is terminated by the solidification of the previously liquid matrix, e.g. by cooling of the melt, or chemical crosslinking of a reaction mixture.

It is not essential that the abovementioned steps proceed sequentially; they can also at least to some extent take place simultaneously. In particular, growth of the foam cells is often associated with simultaneous cell ageing. The combined effect of the abovementioned steps exerts a decisive influence on properties of the resultant foam, an example being average cell size, cell size distribution or cell density. By way of example, the cell density of the foam is determined by the number of initial cell nuclei and also by the ageing of the foam cells formed therefrom, while the size of the cells depends mainly on the cell growth rate and on cell ageing.

An important application sector for foams is use thereof as insulation material, in particular for thermal insulation. Foams with maximal effectiveness as insulation foams are advantageously produced with relatively low density <100 kg/m³ and—as significant criterion—maximal number of small closed cells (high cell density). The more fine-celled the foam, the lower its thermal conductivity, i.e. the better its insulation properties.

The object to be achieved by the present invention therefore consists in the provision of particularly fine-celled foams, preferably particularly fine-celled polyurethane foams (PUR foams) with average cell size preferably below 0.2 mm, in particular fine-celled rigid polyurethane foams with average cell size preferably below 0.2 mm.

Surprisingly, it has been found in the context of the present invention that retardation of cell ageing, in particular retardation of cell ageing caused by Ostwald ripening, permits provision of particularly fine-celled foams, in particular with regard to polyurethane foams, preferably rigid polyurethane foams.

The present invention provides use of an Ostwald hydrophobe in the production of polymer foams, preferably polyurethane foam, in particular rigid polyurethane foam, from liquid reaction mixtures, to retard cell ageing, in particular to retard cell ageing caused by Ostwald ripening. The term Ostwald hydrophobe will be explained hereinbelow.

The present invention also provides a process for the production of polymer foams, in particular polyurethane foam, in particular rigid polyurethane foam, from liquid reaction mixtures, where the process is carried out in the presence of an additional substance to retard cell ageing, in particular to retard cell ageing caused by Ostwald ripening (i.e. shrinkage and disappearance of small cells without coalescence) rather than by coalescence.

The term “liquid” reaction mixtures comprises all substances and substance mixtures in liquid physical condition, in particular including melts and emulsions.

The term polyurethane foams means foams which are formed by reaction of polyisocyanates with compounds reactive towards these, preferably having OH groups (“polyols”) and/or NH groups, in the presence of chemical blowing agents (e.g. water, which reacts with isocyanate with formation of carbon dioxide) and/or physical blowing agents (e.g. volatile alkanes such as n-pentane or cyclopentane or halogenated hydrocarbons), and also generally of foam stabilizers, catalysts and optionally other additions. Polyurethane foams can be either flexible (“flexible foams”) or rigid (“rigid foams”), and are used for very many different applications corresponding to their variety of mechanical properties. Thermal insulation is a large application sector, in particular for rigid polyurethane foams. As mentioned above, fine-celled foams are particularly advantageous for this purpose.

The present invention in particular provides access to rigid PUR foams exhibiting a further improvement in fine-celled character and therefore in insulation properties. The average cell size of the resultant polyurethane foams is preferably below 0.2 mm. The average cell size is determined by counting the number of cells occurring on a radial line measuring 10 mm in a representative region of the foam. The measured distance divided by the number of cells gives the average cell size.

For the purposes of this invention, the extent of cell ageing is preferably quantified by using the standardized ageing rate kstand.

In a preferred embodiment of the invention, the standardized ageing rate k_{stand} in the process of the invention, which can be determined as described below, is ≤1.0 ×10⁻³ mm²/s, preferably ≤0.9×10⁻³ mm²/s, particularly preferably ≤0.8×10⁻³ mm²/s. A possible lower limit exists at k≥0, preferably k≥0.1×10⁻⁵, in particular ≥0.1×10⁻⁴. The same applies to the use according to the invention.

The procedure for determining the standardized ageing rate k_{stand} is as follows.

In the as yet unpublished European Patent Application EP15196930.0 a videomicroscopic method is described for detailed observation of cell growth and cell ageing in foaming procedures. Reference is hereby made to the entire content of the said as yet unpublished European Patent Application EP15196930.0, and the entire disclosure therein is hereby incorporated into the present description. The standardized ageing rate k_{stand} can be determined for the purposes of the present invention by using videomicroscopic methods for observation of cell growth and cell ageing during foaming procedures, in particular the method specified in the as yet unpublished European Patent Application EP15196930.0. The main features thereof are summarized below.

This method is based on videomicroscopic observation of foaming processes over a defined continuous period which should preferably start as early as possible (in particular directly after discharge of the foaming composition from the foaming machine) and should preferably continue into the region where no further chronological change occurs (hardened foam). This permits observation of chronological changes in cell structures. Because ageing phenomena generally occur through interaction between two or more cells, the chronological change in a sufficiently large assembly of cells is studied. In order to permit monitoring of the chronological changes in an assembly of cells with sufficient precision, the image refresh rate of the video recording must be high, to the extent that changes in position and size of the cells from one image to the next are small in comparison with the cell diameter. It thus becomes possible to identify cells unambiguously and to determine their properties at various times in the foaming process. Cell ageing is recorded by monitoring the chronological decrease in the number of cells in a defined cell assembly. The term cell assembly means a group of a plurality of cells that are spatially adjacent and can be recorded by videomicroscopic methods. The cell assembly can in particular be a cell population within a defined volume. This volume can either be selected fixedly, i.e. by way of example being the entire image section or a spatially fixed part thereof, or can follow the spatial movement and expansion of the foaming composition, this being preferable for the purposes of this invention. In order to achieve an advantageous statistical observation result, it is preferable for the purposes of the present invention to observe a cell assembly having at least 20 cells, preferably at least 30, with particular preference at least 40.

The chronological decrease in the cell number here is determined by extracting individual images from the videomicroscopic observation of the foaming process at regular time intervals. Within each of these individual images a standardized region is then defined within which cell ageing is examined. This region must be adjusted so that it is appropriate to the spatial movement and expansion of the cell assembly observed; this is achieved by using a “floating observation window”. To this end, cells are identified which form corners of a polygon. All of the cells within the boundaries of the polygon are included in the evaluation. It is necessary here to ensure that these corner cells appear in all of the individual images examined. The polygon represented by these cells therefore changes from image to image. For identification of the “corner cells” in the individual images it can be advantageous to examine the chronologically intervening video sequences. In the case of foams exhibiting a high level of expansion it can be advantageous to define the floating evaluation window in the individual image at the end of the evaluation period, and then to identify the corner cells in each individual image in reverse chronological sequence. It is thus possible to avoid migration of the window boundaries out of the image section. The cell number in the observed area at the respective points in time can then be determined by counting of the cells. In order to ensure comparability of the cell numbers thus determined in different foams, the cell numbers are standardized on the basis of the size of the observed area in the final individual image (which represents the hardened foam). Quantitative conclusions concerning cell ageing can be obtained by then plotting the standardized cell number as a function of time. In parallel with this procedure, qualitative assessment of the videomicroscopically recorded foaming process can be used to determine whether ageing phenomena derive from coalescence (i.e. fusion of two or more cells) or Ostwald ripening (i.e. shrinkage of small cells).

For the purposes of the present invention, mathematical evaluation for quantification of cell ageing was added to the videomicroscopy method described in the abovementioned European Patent Application EP15196930.0:

According to the invention, preference is given here to modelling of the data by means of an e function of the general form N(t)=(N₀−Nᵤ)e^{-kt}+Nᵤ, where N(t) is the standardized cell number at the point in time t, No is the standardized initial cell number at the point in time t=0, Nᵤ is the standardized cell number in the hardened foam for t→∞ and k is the ageing rate. According to the invention it is preferable to state the standardized cell numbers Nₜ, N₀ and Nᵤ per square millimetre (1/mm²); the preferred physical unit for the ageing rate k is 1/second (1/s).

The effectiveness of measures for the suppression of ageing phenomena is reflected here firstly in the ageing rate k, which is directly linked to the rate of cell ageing. Retardation or suppression of ageing phenomena moreover increases the standardized cell number in the hardened foam Nᵤ. A quantitative evaluation of the effectiveness of methods for the inhibition of ageing phenomena can therefore be achieved by way of the said two variables. For the purposes of the present invention, the ageing rate k_{stand}=k/Nᵤ, standardized on the basis of Nᵤ, is defined as measure of effectiveness. The preferred physical unit of the standardized ageing rate k_{stand} here is square millimetres per second (mm²/s).

It has been found that during the production of polyurethane foams it is Ostwald ripening that is responsible for most of the cell ageing, whereas cell coalescence is suppressed by the foam stabilizers conventionally used and adjusted to individual circumstances, to such an extent that it is almost insignificant.

The ageing rates preferred according to the invention are achieved by using, according to the invention, an additional substance to retard cell ageing, in particular to retard cell ageing which is caused by Ostwald ripening rather than by coalescence. No such additional substances or other targeted measures for the reduction of Ostwald ripening have hitherto been described for foams.

The additional substance of the invention to retard cell ageing, in particular to retard cell ageing which is caused by Ostwald ripening rather than by coalescence, can reduce the standardized ageing rate kₙₒᵣₘ.

In a preferred embodiment of the invention, the process of the invention for the production of foams, in particular polyurethane foams (inclusive of polyisocyanurate- and polyurea-based foams, and also mixed forms of these), features use of a quantity of at most 5% by mass, preferably at most 3% by mass, particularly preferably at most 1.5% by mass, of the additional substance of the invention, based on the total mass of the foam formulation (inclusive of the blowing agents). An example of a possible lower limit is 0.0001% by mass, preferably 0.1% by mass, in particular 0.2% by mass. The same applies to the use according to the invention. Accordingly it is preferable that the total quantity of Ostwald hydrophobe is from 0.0001 to at most 5% by mass, preferably at most 3% by mass, particularly preferably at most 1.5% by mass, based on the total mass of the foam formulation inclusive of the blowing agents.

In another preferred embodiment of the invention, the process of the invention features reduction of the standardized ageing rate k_{stand} by at least 20%, preferably by at least 30%, particularly preferably by at least 40%, when measured in comparison with the value of k_{stand} from the same production process (analogous formulation, identical foaming conditions) without addition of the additional substance of the invention. A possible upper limit is 100%, preferably 90%, in particular 80%. The same applies to the use according to the invention.

The additional substance of the invention is preferably a volatile substance with boiling point below 150° C., particularly preferably below 100° C. A possible lower limit is preferably −30° C., in particular −20° C. Preferred additional substances of the invention are those having low solubility in the liquid foam matrix. Low solubility means in particular that, when the substances are used at a concentration of at most 5% by mass, preferably at most 3% by mass, particularly preferably at most 1.5% by mass, they lead to visible haze and/or phase separation. In the case of foams which are produced via foaming of multicomponent reactive systems, this criterion preferably applies independently to all of the individual components. By way of example, in the case of a polyurethane system the additional substance of the invention should preferably have poor solubility not only in the polyol mixture (A component) but also in the isocyanate (B component). The term “Ostwald hydrophobe” is used for the purposes of this invention for such additional substances of the invention.

For the inventive use it is therefore preferable that the Ostwald hydrophobe is a compound which, under standard conditions, has a boiling point below 150° C. and preferably low solubility in the liquid foam matrix, where this means that, when the concentration used thereof is at most 5% by mass, preferably at most 3% by mass, particularly preferably at most 1.5% by mass, it leads to visible haze and/or phase separation, and in the case of foams produced via foaming of multicomponent reactive systems the said criterion preferably applies independently to all of the individual components, and in particular in the case of a polyurethane system the Ostwald hydrophobe preferably has low solubility not only in the polyol mixture, corresponding to A component, but also in the isocyanate, corresponding to B component.

Examples of additional substances of the invention, i.e. suitable Ostwald hydrophobes, which contribute to the retardation of cell ageing, in particular to the retardation of cell ageing caused by Ostwald ripening rather than by coalescence, and which consequently can be used for the purposes of the present invention to reduce the ageing rate kstand, are fluorinated hydrocarbons, ethers and ketones in which at least 50%, preferably at least 80%, particularly preferably 100%, of the hydrogens have been replaced by fluorine atoms. The compounds can be saturated or unsaturated, linear, branched or cyclic. The same preferably applies to the use according to the invention.

Preferred substances (Ostwald hydrophobes) for the purposes of the present invention are perfluorinated hydrocarbons, particularly preferably perfluoropentane C₅F₁₂, perfluorohexane C₆F₁₄, perfluorocyclohexane C₆F₁₂, perfluoroheptane C₇F₁₆, perfluorooctane C₅F₁₅, olefins with the molecular formulae C₅F₁₀, C₆F₁₂, C₇F₁₄ and/or C₅F₁₆, very particularly preferably the dimer of 1 ,1,2,3,3,3-hexafluoro-1-propene, in particular 1,1,1,2,3,4,5,5,5-nonafluoro-4-(trifluoromethyl)pent-2-ene or 1,1,1,3,4,4,5,5,5-nonafluoro-2-(trifluoromethyl)pent-2-ene and/or mixtures thereof.

Other preferred substances (Ostwald hydrophobes) are fluorocarbons, particularly preferably olefins with the molecular formulae C₄H2F₆ (by way of example hexafluoroisobutylene), C₅H2F₅, C₆H2F₁o, C₇H2F₁₂ and/or C₅₁-12F₁₄, and also olefins with the general formula

H₂C═CH—RF
where R^{F} is a monovalent, perfluorinated, saturated organic moiety, preferably —CF₃, —C₂F₅, —C₃F₇, —C₄F₉, —C₄F₁₁, —C₆F₁₃ and/or —C₇F₁₅.

Further preferred substances (Ostwald hydrophobes) are ethers having one or two perfluorinated moieties, particularly preferably compounds of the general formula

R—O—R^{F}
where RF is as defined above, preferably —C₃F₇, —C₄F₉, -0₅Fᵢᵢ, —C₆F₁₃ or —C₇F₁₅,
R is a monovalent, saturated hydrocarbon moiety, preferably methyl moieties or ethyl moieties,
   or

R^{F}—O—CF═CF₂
where RF is as defined above, preferably —CF₃ or —C₂F₅.

Other preferred substances (Ostwald hydrophobes) are ketones having two perfluorinated moieties, particularly preferably 1,1,1,2,2,4,5,5,5-nonafluoro-4-(trifluoromethyl)-3-pentanone.

Other examples are silanes and/or siloxanes which bear methyl substituents or higher hydrocarbon substituents, preferably up to C₃, where these may be saturated or unsaturated, linear, branched or cyclic, and also non-halogenated, or partially or fully halogenated, in particular fluorinated.

Preferred substances (Ostwald hydrophobes) for the purposes of the present invention are tetramethylsilane and compounds derived therefrom of the general formula

(CH₃)₃Si—R
where R is H, ethyl, vinyl, allyl, chloromethyl, bromomethyl, methoxymethyl, trifluoromethyl or methoxy.

Other preferred substances (Ostwald hydrophobes) are hexamethyldisilane, tetraethylsilane, trifluoromethyltriethylsilane and/or trivinylsilane.

Other preferred substances (Ostwald hydrophobes) are hexamethyldisiloxane and compounds derived therefrom of the general formula

R—(CH₃)₂Si—O—Si(CH₃)₂—R
where R is H, ethyl, vinyl, allyl, chloromethyl, bromomethyl, methoxymethyl, trifluoromethyl or methoxy.

Other preferred substances (Ostwald hydrophobes) are octamethyltrisiloxane and/or heptamethyltrisiloxane (CH₃)₃Si—O—Si(CH₃)H—O—Si(CH₃)₃.

The substances (Ostwald hydrophobes) mentioned for the retardation of ageing phenomena, in particular for the retardation of cell ageing caused by Ostwald ripening rather than by coalescence, can if desired be used individually or else in combination. It is also possible to mix these substances with other substances, preferably with blowing agents. These mixtures can be azeotropes. By way of example, azeotropic mixtures of ethers having one or two perfluorinated moieties and 1,2-dichloroethylene are known.

A preferred embodiment of the present invention is a process for the production of fine-celled polyurethane foams with average cell size preferably below 0.2 mm, particular preference being given to fine-celled rigid polyurethane foams with average cell size preferably below 0.2 mm. The same applies to the use according to the invention.

It is preferable here to use, alongside the additional substance of the invention to retard cell ageing, in particular to retard cell ageing caused by Ostwald ripening rather than by coalescence, the following raw materials.

1. Polyols

Polyols for the production of foams, preferably PUR foams, are known per se. Particularly suitable polyols for the purposes of this invention are any of the organic substances having a plurality of groups reactive towards isocyanates, and also preparations of the said substances. Preferred polyols are any of the polyether polyols and polyester polyols usually used for the production of polyurethane foams. Polyether polyols are obtained by reacting polyfunctional alcohols or amines with alkylene oxides. Polyester polyols are based on esters of polybasic carboxylic acids (mostly phthalic acid or terephthalic acid) with polyhydric alcohols (mostly glycols). Polyols used are appropriate for the properties required from the foams, as described by way of example in: US 2007/0072951 A1, WO 2007/111828 A2, US 2007/0238800, U.S. Pat. No. 6,359,022 B1 or WO 96 12759 A2. Preferably usable vegetable-oil-based polyols are likewise described in various patent documents, for example in WO 2006/094227, WO 2004/096882, US 2002/0103091, WO 2006/116456 and EP 1 678 232.

2. Blowing Agents

Blowing agents for the production of foams, preferably PUR foams, are known per se. It is usual to use a physical blowing agent, i.e. a volatile liquid (boiling point below 100° C., preferably below 70° C.) or a gas. Suitable physical blowing agents for the purposes of this invention are gases, for example liquefied CO₂, and volatile liquids, for example hydrocarbons having from 3 to 5 carbon atoms, preferably cyclo-, iso- and n-pentane, fluorocarbons, preferably HFC 245fa, HFC 134a and HFC 365mfc, HFO-1234zeE, HFO-1234yf, HFO-1336mzzZ and HFO-1336mzzE, fluorochlorocarbons, preferably HCFC 141b and HFO-1233zd-E, oxygen-containing compounds such as methyl formate and dimethoxymethane, and chlorocarbons, preferably 1,2-dichloroethane.

The preferred quantities used of physical blowing agent depend entirely on the desired density of the foam to be produced and are typically in the range from 1 to 40 parts by mass, based on 100 parts by mass of polyol.

Materials that can be present are not only physical blowing agents but also chemical blowing agents which react with isocyanates with gas evolution, an example being water or formic acid.

3. Foam Stabilizers

Foam stabilizers for the production of foams, preferably PUR foams, are known per se. Preferred foam stabilizers are surface-active substances, preferably silicone surfactants (polyether-polydimethylsiloxane copolymers). Typical quantities used of polyethersiloxane foam stabilizers are from 0.5 to 5 parts by mass per 100 parts by mass of polyol, preferably from 1 to 3 parts by mass per 100 parts by mass of polyol. Suitable silicone surfactants are described by way of example in EP 1873209, EP 1544235,

DE 10 2004 001 408, EP 0839852, WO 2005/118668, US 20070072951, DE 2533074, EP 1537159, EP 533202, U.S. Pat. No. 3,933,695, EP 0780414, DE 4239054, DE 4229402 and EP 867464 and are marketed by way of example with the trademark Tegostab® by Evonik Industries. The siloxanes can be produced as described in the prior art. Particularly suitable production examples are described by way of example in U.S. Pat. No. 4,147,847, EP 0493836 and U.S. Pat. No. 4,855,379.

4. Catalysts

Catalysts for the production of foams, preferably PUR foams, are known per se. Particularly suitable catalysts for the purposes of this invention are preferably catalysts which catalyse the gel reaction (isocyanate-polyol), the blowing reaction (isocyanate-water) and/or the di- and/or trimerization of the isocyanate. Typical examples of suitable catalysts are the amines triethylamine, dimethylcyclohexylamine, tetramethylethylenediamine, tetramethylhexanediamine, pentamethyl-diethylenetriamine, pentamethyldipropylenetriamine, triethylenediamine, dimethylpiperazine, 1,2-dimethyl-imidazole, N-ethylmorpholine, tris(dimethylaminopropyl)hexahydro-1,3,5-triazine, dimethylaminoethanol, dimethylaminoethoxyethanol and bis(dimethylaminoethyl) ether, tin compounds such as dibutyltin dilaurate and potassium salts such as potassium acetate and potassium 2-ethylhexanoate. Suitable catalysts are mentioned by way of example in EP 1985642, EP 1985644, EP 1977825, US 2008/0234402, EP 0656382 B1, US 2007/0282026 A1 and the patent documents cited therein.

Preferred quantities of catalyst depend on the type of catalyst and are usually in the range from 0.05 to 5 pphp (=parts by mass, based on 100 parts by mass of polyol) and, respectively, from 0.1 to 10 pphp for potassium salts.

5. Flame Retardants (Optional)

Suitable flame retardants for the purposes of this invention are preferably liquid organophosphorus compounds such as halogen-free organophosphates, e.g. triethyl phosphate (TEP), halogenated phosphates, e.g. tris(1-chloro-2-propyl) phosphate (TCPP) and tris(2-chloroethyl) phosphate (TCEP), and organic phosphonates, e.g. dimethyl methanephosphonate (DMMP), dimethyl propanephosphonate (DMPP), or solids such as ammonium polyphosphate (APP) and red phosphorus. Other suitable flame retardants are halogenated compounds, for example halogenated polyols, and also solids, for example expandable graphite and melamine.

6. Other Optional Additives

It is also possible to use other components, for example crosslinking agents, fillers, dyes, antioxidants and thickeners/rheology additives.

7. Isocyanates

Any of the isocyanate compounds suitable for the production of polyurethane foams, in particular rigid polyurethane foams or rigid polyisocyanurate foams, can be used as isocyanate component. The isocyanate component preferably comprises one or more organic isocyanates having two or more isocyanate functions. Examples of suitable isocyanates for the purposes of this invention are any of the polyfunctional organic isocyanates, for example diphenylmethane 4,4′-diisocyanate (MDI), toluene diisocyanate (TDI), hexamethylene diisocyanate (HMDI) and isophorone diisocyanate (IPDI). A particularly suitable material is the mixture known as “polymer MDI” (“crude MDI”) made of MDI and of analogues of higher condensation level with average functionality from 2 to 4. Examples of suitable isocyanates are mentioned in EP 1 712 578 A1, EP 1 161 474, WO 058383 A1, US 2007/0072951 A1, EP 1 678 232 A2 and WO 2005/085310.

The ratio of isocyanate to polyol, expressed as index, is preferably in the range from 40 to 500, with preference from 100 to 350. This index describes the ratio of isocyanate actually used to calculated isocyanate (for a stoichiometric reaction with polyol). An index of 100 represents a molar reactive-group ratio of 1:1.

The process of the invention for the production of polyurethane foams, in particular rigid polyurethane foams, can be carried out by the known methods, for example by the manual mixing process or preferably with the aid of foaming machines. If the process is carried out by using foaming machines, it is possible to use high-pressure or low-pressure machines. The process of the invention can be carried out either batchwise or continuously. The same applies to the use according to the invention.

A summary of the prior art, the raw materials that can be used, and processes that can be used is found in “Ullmann's Encyclopedia of Industrial Chemistry” Vol. A21, VCH, Weinheim, 4th Edition, 1992, pp. 665 to 715.

A preferred formulation for rigid polyurethane foam or rigid polyisocyanurate foam for the purposes of this invention will give a density of preferably from 20 to 150 kg/m³ and preferably has the composition specified in Table 1, and in particular has an isocyanate index of from 40 to 500.

TABLE 1
Composition of a formulation
for rigid polyurethane foam or rigid
polyisocyanurate foam

| Component | Parts by weight |
|---|---|
| Polyol | 100 |
| Blowing agent | from 1 to 40 |
| Water | from 0.1 to 30 |
| Foam stabilizer | from 0.5 to 5 |
| Amine catalyst | from 0.05 to 5 |
| Potassium trimerization | from 0 to 10 |
| catalyst | |
| Ostwald hydrophobe | from 0.1 to 10 |
| Flame retardant | from 0 to 50 |
| Isocyanate index: | |
| from 40 to 500 | |

The present invention also provides a polymer foam, preferably with average cell size below 0.2 mm, preferably polyurethane foam, in particular rigid polyurethane foam, produced by a process as described above or by a use as described above.

The present invention also provides the use, for thermal insulation, in particular in refrigeration equipment and construction applications, of the polymer foam of the invention, obtainable as described above.

### EXAMPLES

The present invention is described by way of example in the Examples set out below.

### Comparative Example 1

### Production of a Rigid PU Foam Without Measures for the Avoidance of Ageing Processes Caused by Ostwald Ripening Rather Than by Coalescence

Formation of a rigid PU foam was observed by using a VHX 2000 digital microscope from Keyence, equipped with a VH-Z20R/W zoom objective. The method selected for the experiment was the transmitted-light method mentioned in the European Patent Application EP15196930.0. For this, the objective was clamped into the microscope unit with viewing direction upwards and placed below a Petri dish resting on a support ring. An optical conductor attached to the lamp housing of the microscope control unit served as illumination source. Protection was provided here by surrounding the open end of the optical conductor with a single-use screw-lid glass container with flat base, equipped with lid which had been modified to provide an appropriate passage and through which the optical conductor is passed. The illumination source thus constructed was placed at a distance of about 5 mm above the base of the Petri dish, the direction of illumination here being downwards. Care was taken here to ensure that the cone of illumination was as precisely as possible within the cone of observation of the objective. The magnification selected for observation of the foam-forming procedure was 100×. The focus of the objective was adjusted to be at the base of the Petri dish.

The PU foam system used was a cyclopentane-blown rigid PU foam produced via reaction of 100 parts by weight of a polyol mixture comprising an aliphatic polyether polyol (glycerol/sorbitol-started) with OH number 470 mg KOH/g and an autocatalytic polyether polyol (o-TDA-started) with OH number 460 mg KOH/g in a mass ratio of 3:2, with 135 parts by weight of commercially available polymeric diphenylmethane diisocyanate (pMDI with viscosity 200 mPas). The polyol mixture here also comprised—based on 100 parts by weight of the main polyol—2.6 parts by weight of water, 1.5 parts by weight of the catalyst dimethylcyclohexylamine, 1.0 part by weight of the catalyst pentamethyldiethylenetriamine, 0.5 part by weight of the catalyst tris(dimethylaminopropyl)hexahydro-1,3,5-triazine, 2.0 parts by weight of the polyethersiloxane-based foam stabilizer Tegostab B 8491 from Evonik Industries AG, and also 15.0 parts by weight of cyclopentane. The reaction components were mixed in the mixing head of a high-pressure foam machine from Krauss-Maffei (RIM-Star MiniDos with MK12/18ULP-2KVV-G-80-I mixing head) at 150 bar. Directly after discharge from the mixing head, about 5 g of the reaction mixture were placed into the Petri dish of the microscopy setup and monitored videomicroscopically for 3 minutes at 100× magnification. Simply by using qualitative observation of the recorded images, it was possible to observe distinct ageing due to Ostwald ripening, i.e. the slow disappearance of small foam bubbles without coalescence. In contrast, almost no ageing phenomena due to coalescence were discernible.

Ostwald ripening during the course of the foaming process was then further examined by extracting 19 individual images from the recorded video at uniform time intervals within the observation period of from 10 to 110 sec. On the basis of the final individual image after 110 sec, four cells were then identified which were within the four corners of the image and which did not age during foaming, and which were therefore visible on all of the individual images. A rectangle representing the observation window at the respective point in time was then drawn around the said cells in all of the individual images. This procedure ensured that the growth rate of the observation window was approximately the same as that of the PU foam to be studied, thus allowing study of Ostwald ripening decoupled from the growth of the foam. The number of foam cells within the observation window at each point in time was then determined, standardized on the basis of the size of the observation window in the final individual image, and then plotted semilogarithmically as a function of time. FIG. 1 shows the result. As can be seen, the number of bubbles decreases constantly with increasing reaction time. For mathematical modelling, the data were fitted to an e function of the form N(t)=(N₀−Nᵤ)e^{-kt}+Nᵤ. This gave a standardized initial bubble number N₀=1626.7 mm⁻², an ageing rate k=0.120 s⁻¹ and a standardized bubble number Nᵤ=103.2 mm⁻² for the hardened foam. From these values it is possible to determine a standardized ageing rate kₙₒᵣₘ=1.16×10⁻³ mm²/s.

### Inventive Example 2

### Production of a Rigid PU Foam Comprising Ostwald Hydrophobe

These experiments used the reaction system described in Comparative Example 1, to which 2 parts by weight of perfluoroisohexene were added. For this, the perfluoroisohexene was first mixed with cyclopentane; this mixture was then added as described in Example 1 to the polyol phase of the reaction system. The system was foamed and observed videomicroscopically by analogy with Example 1. Simply from qualitative examination of the recorded images, it was possible to discern significant retardation of ageing processes when comparison is made with the perfluoroisohexene-free PU system. The curve for standardized cell number N(t) as a function of time was then determined from the recorded videomicroscopic images as described in Example 1. FIG. 2 shows the result. By mathematical modelling of the data using the general expression N(t)=(N₀−Nᵤ)e^{-kt}+Nᵤ, it was possible to determine a standardized initial bubble number N₀=1473.4 mm⁻², an ageing rate k=0.162 s⁻¹ and a standardized bubble number Nᵤ=295.4 mm⁻² for the hardened foam. This gives a standardized ageing rate k_{stand}=5.48×10⁻⁴ mm²/s. When comparison is made with the perfluoroisohexene-free PU system from Example 1, therefore, a marked decrease of the standardized ageing rate k_{stand} can be discerned; this is attributable to retarded cell ageing. Microscopic examination of the finished foam moreover revealed that the reduced cell-ageing rate caused a significant reduction in the average size of the foam cells. It was below 0.2 mm.

1. A method or making polymer foams from liquid reaction mixtures, to retard cell ageing, in particular to retard cell ageing caused by Ostwald ripening, said method comprising the step of
a) adding from from 0.0001 to 5% by mass an Ostwald hydorphobe to a misture for the polymer foam, and
b) reacting the mixture of step a)
wherein the polymer foam has a standardized ageing rate k_{stand} of ≤1.0×10⁻³ mm²/s.

2. The method according to claim 1, wherein the standardized ageing rate k_{stand} is ≤0.9×10⁻³ mm²/s.

3. The method according to claim 1, wherein the total quantity of Ostwald hydrophobe is from 0.0001 to at most 3% by mass, based on the total mass of the foam formulation inclusive of the blowing agents.

4. The method according to claim 1, wherein the standardized ageing rate k_{stand}, which can be determined as described herein, is reduced by at least 20%, when measured in comparison with the value of k_{stand} without addition of the additional substances to retard cell ageing.

5. The method according to claim 1, wherein the Ostwald hydrophobe, under standard conditions, has a boiling point below 150° C. and low solubility in the liquid foam matrix, where this means that, when the concentration used thereof is at most 5% by mass, it leads to visible haze and/or phase separation, and in the case of foams produced via foaming of multicomponent reactive systems the said criterion preferably applies independently for all of the individual components, and in particular in the case of a polyurethane system the Ostwald hydrophobe prcfcrably has low solubility not only in the polyol mixture, corresponding to A component, but also in the isocyanate, corresponding to B component.

6. The method according claim 1, wherein the Ostwald hydrophobe is selected from the group consisting of fluorinated hydrocarbons, ethers and/or ketones in which at least 50%, of the hydrogens have been replaced by fluorine atoms, where these compounds can be saturated or unsaturated, and also linear, branched or cyclic.

7. The method according to claim 6, wherein the Ostwald hydrophobe is selected from the group consisting of perfluorinated hydrocarbons, perfluoropentane C₅F₁₂, perfluorohexane C₆F₁₄, perfluorocyclohexane C₆F₁₂, perfluoroheptane C₇F₁₆, perfluorooctane C₈F₁₈, olefins with the molecular formulae C₅F₁₀, C₆F₁₂, C₇F₁₄ and/or C₈F₁₆, dimer of 1,1,2,3,3,3-hexafluoro-1-propene, 1,1,1,2,3,4,5,5,5-nonafluoro-4-(trifluoromethyl)pent-2-ene or 1,1,1,3,4,4,5,5,5 -nonafluoro-2-(trifluoromethyl)pent-2-ene and/or mixtures thereof.

8. The method according to claim 1, wherein the Ostwald hydrophobe is selected from fluorocarbons with olefin function, C₄H2F₆, hexafluoroisobutylene, C₅H2F₈, C₆H2Fio, C₇H2F₁₂ and/or C₈H2F₁₄, or olefins with the general formula
H₂C═CH—R^{F}
where R^{F} is a monovalent, perfluorinated, saturated organic moiety.

9. Use according to claim 1, wherein the Ostwald hydrophobe is selected from the group consisting of ethers having one or two perfluorinated moieties having the general formula
R—O—R^{F}
where R^{F} is a monovalent, perfluorinated, saturated organic moiety,
R is a monovalent, saturated hydrocarbon moiety,
or
R^{F}−O—CF═CF₂
where R^{F} is a monovalent, perfluorinated, saturated organic moiety.

10. The method according to claim 1, wherein the Ostwald hydrophobe is selected from the group consisting of ketones having two perfluorinated moieties, particularly preferably 1,1,1,2,2,4,5,5,5-nonafluoro-4-(trifluoromethyl)-3-pentanone.

11. The method according to claim 1, wherein the Ostwald hydrophobe is selected from the group consisting of silanes and/or siloxanes which bear methyl substituents or higher hydrocarbon substituents, where these may be saturated or unsaturated, linear, branched or cyclic, and also non-halogenated, or partially or fully halogenated, in particular fluorinated, where preference is given to the following:
i) tetramethylsilane and compounds of the general formula
(CH₃)₃Si—R
derived therefrom, where R is H, ethyl, vinyl, allyl, chloromethyl, bromomethyl, methoxymethyl, trifluoromethyl or methoxy,
ii) hexamethyldisilane, tetraethylsilane, trifluoromethyltriethylsilane and/or trivinylsilane,
iii) hexamethyldisiloxane and compounds of the general formula
R—(CH₃)₂Si—O—Si(CH₃)₂—R
derived therefrom, where R is H, ethyl, vinyl, allyl, chloromethyl, bromomethyl, methoxymethyl, trifluoromethyl or methoxy,
iv) octamethyltrisiloxane and/or heptamethyltrisiloxane (CH₃)₃Si—O—Si(CH₃)H—O—Si(CH₃)₃.

12. The method according to claim 1, wherein the polymer foam is a a rigid polyurethane foam, and results from reaction of one or more polyol components with one or more isocyanate components, in the presence of at least one urethane catalyst and/or isocyanurate catalyst, and of at least one blowing agent.

13. The method according to claim 1 wherein the polymer foam have an average cell size below 0.2 mm.

14. A polymer foam having an average cell size below 0.2 mm. produced according to claim 1.

15. A thermal insulation comprising the polymer foam according to claim 14.

16. A method or making rigid polyurethane foam from liquid reaction mixtures, to retard cell ageing, in particular to retard cell ageing caused by Ostwald ripening, said method comprising the steps of
a) adding from from 0.0001 to 3% by mass an Ostwald hydorphobe to a misture for the polymer foam; and
b) reacting the mixture of step a)
wherein the polymer foam has a standardized ageing rate k_{stand} of ≤0.8×10⁻³ mm²/s.

17. The method according to claim 16, wherein the total quantity of Ostwald hydrophobe is from 0.0001 to 1.5% by mass, based on the total mass of the foam formulation inclusive of the blowing agents.

18. The method according to claim 16, wherein the standardized ageing rate kstand, which can be determined as described herein, is reduced by at least 50%, when measured in comparison with the value of k_{stand} without addition of the additional substances to retard cell ageing.

19. The method according to claim 16, wherein the Ostwald hydrophobe, under standard conditions, has a boiling point below 150° C. and low solubility in the liquid foam matrix, where this means that, it leads to visible haze and/or phase separation, and in the case of foams produced via foaming of multicomponent reactive systems the said criterion preferably applies independently for all of the individual components, and in particular in the case of a polyurethane system the Ostwald hydrophobe has low solubility not only in the polyol mixture, corresponding to A component, but also in the isocyanate, corresponding to B component.

20. The method according to claim 6, wherein the Ostwald hydrophobe is selected from the group consisting of perfluorinated hydrocarbons, perfluoropentane C₅F₁₂, perfluorohexane C₆F₁₄, perfluorocyclohexane C₆F₁₂, perfluoroheptane C₇F₁₆, perfluorooctane C₈F₁₈, olefins with the molecular formulae C₅F₁₀, C₆F₁₂, C₇F₁₄ and/or CsF₁₆, dimer of 1,1,2,3,3,3-hexafluoro-1-propene, 1,1,1,2,3,4,5,5,5-nonafluoro-4-(trifluoromethyl)pent-2-ene or 1,1,1,3,4,4,5,5,5-nonafluoro-2-(trifluoromethyl)pent-2-ene and/or mixtures thereof.
